(19) United States
(12) Patent Application Publication
(10) Pub. No.: US 2004/0045769 A1
(43) Pub. Date: Mar. 11, 2004

(54) Emergency escape system

(75) Inventors: Yoav Barzilai, Ashkelon (IL); Rafi Salhov, Ashkelon (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignees: Reshafim (metal doors) Ltd.(50%); Yoav Barzilai (50%)

(21) Appl. No.: 10/237,034

(22) Filed: Sep. 9, 2002

(51) Int. Cl. A62B 1/06

(52) U.S. Cl. 182/70

(57) ABSTRACT

An emergency escape system includes an escape apparatus and a hollow door. A majority of the escape apparatus is storable within an internal volume of the door. A part of the door is removable in order to access the escape apparatus. The escape apparatus includes a cord and a release mechanism. The release mechanism is configured to provide a controlled lowering of a person being lowered on the cord.

### FIELD AND BACKGROUND OF THE INVENTION

The present invention relates to an emergency escape system and, in particular, it concerns the storage of an automatic escape apparatus within a door.

By way of introduction, escape devices for allowing an individual to descend from a building generally require that the escape device is securely installed into an exterior or interior wall of the building. The escape device is typically installed above or near a window or balcony. There are several problems with this method of installation. First, not all walls are suitable for this installation, thereby restricting the positioning of the device. Second, this type of installation is expensive. Third, the escape device housing is visible. Fourth, if the device is installed on an interior wall, the device occupies valuable wall space. Fifth, the device is installed locally and is not typically usable from another window in the building.

There is therefore a need for an escape system that is easily and cheaply installed in a variety of locations, provides compact and concealed storage for the automatic escape apparatus, is available for use from all the emergency exits of a building.

### SUMMARY OF THE INVENTION

The present invention is an emergency escape system and method of operation thereof.

According to the teachings of the present invention there is provided, an emergency escape system comprising: (a) an escape apparatus; and (b) a hollow door, the door having an internal volume, wherein: (i) a majority of the escape apparatus is storable within the internal volume; and (ii) a part of the door is removable in order to access the escape apparatus.

According to a further feature of the present invention, the escape apparatus is configured to be wholly storable within the internal volume.

According to a further feature of the present invention, the escape apparatus is concealed within the door.

According to a further feature of the present invention, the door has a first major panel and a second major panel, the first panel and the second panel being substantially planar.

According to a further feature of the present invention, the first panel and the second panel are substantially parallel.

According to a further feature of the present invention, the door has a first major panel and a second major panel, the first major panel being configured to be removable from a remainder of the door in order to allow access to the escape apparatus.

According to a further feature of the present invention, the door is configured for fitting in a building using at least one hinge such that, when fitted in the building, the door is able to swing horizontally.

According to a further feature of the present invention, the door includes a securing arrangement which is configured to allow removal of the part from a remainder of the door.

According to a further feature of the present invention, the door is reinforced.

According to a further feature of the present invention, the escape apparatus includes a cord.

According to a further feature of the present invention, the escape apparatus includes a storage arrangement configured to store the cord within the door.

According to a further feature of the present invention, the storage arrangement includes a spool.

According to a further feature of the present invention, the storage arrangement includes at least one holder configured to connect the cord to the door, the at least one holder being sufficiently strong that the cord is maintained connected to the door when the cord is not in use and when the cord is needed, the cord is easily released from the door.

According to a further feature of the present invention, the cord is inflammable.

According to a further feature of the present invention, the escape apparatus includes a release mechanism which is configured to provide a controlled lowering of a person being lowered on the cord.

According to a further feature of the present invention, the escape apparatus includes at least one harness, the harness being configured for connection to the cord.

According to a further feature of the present invention, the escape apparatus is configured for a substantially continuous multiple use during a single evacuation.

### BRIEF DESCRIPTION OF THE DRAWINGS

The invention is herein described, by way of example only, with reference to the accompanying drawings, wherein:

FIG. 1 is schematic plan view of an apartment which has an emergency escape system installed therein that is constructed and operable in accordance with a preferred embodiment of the invention;

FIG. 2 is an exploded schematic orthogonal view of the emergency escape system of FIG. 1;

FIG. 3 is an exploded schematic orthogonal view of an emergency escape system that is constructed and operable in accordance with an alternate embodiment of the invention; and

FIG. 4 is a schematic view of an evacuation of a building using the emergency escape system of FIG. 1.

### DESCRIPTION OF THE PREFERRED EMBODIMENTS

The present invention is an emergency escape system and method of operation thereof.

The principles and operation of the emergency escape system according to the present invention may be better understood with reference to the drawings and the accompanying description.

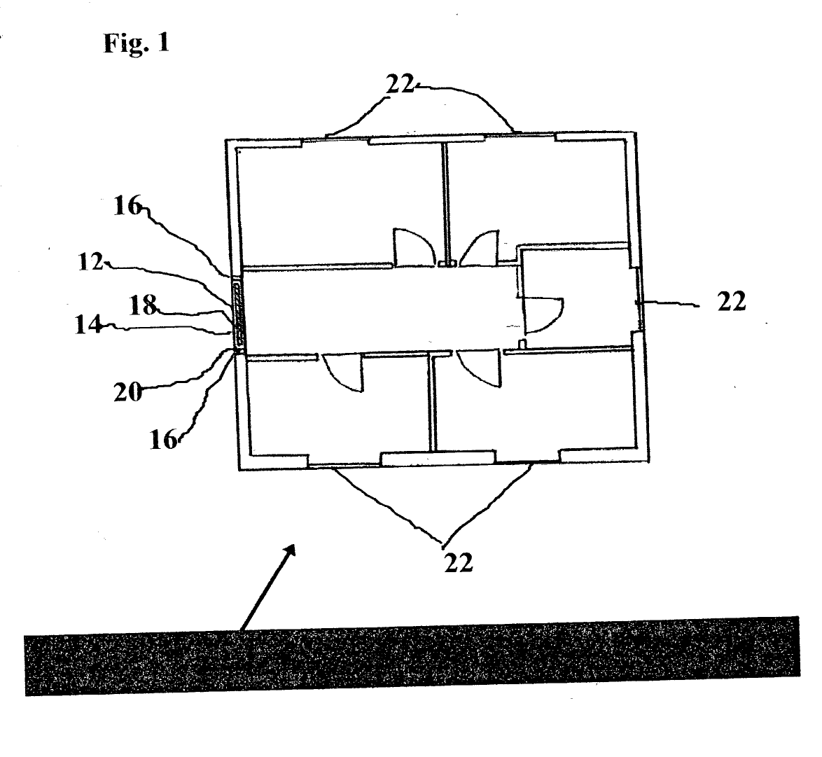

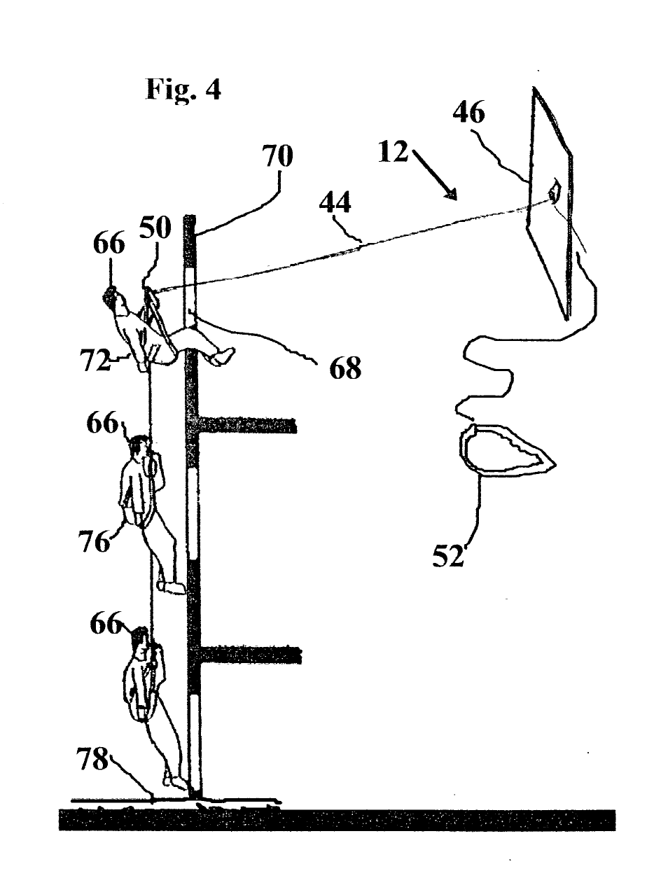

Reference is now made to FIG. 1, which is schematic plan view of a apartment 10 which has an emergency escape system 12 installed therein that is constructed and operable in accordance with a preferred embodiment of the invention. By way of introduction, most offices, houses, or apartments have at least one door 14, which is installed in a reinforced doorway 16. In a most preferred embodiment of the present invention, door 14 is also reinforced. Typically, when door 14 is fitted in reinforced doorway 16, door 14 is designed to resist very high forces, which are impacting on door 14. Reinforced doorway 16 is typically formed by a reinforced concrete frame, a metal frame, or a combination thereof. Therefore, installing an automatic escape apparatus 18 within door 14 is advantageous for several reasons. First, automatic escape apparatus 18 is capable of being easily and securely fitted in to door 14, as will be explained below. Moreover, door 14 can be sold with automatic escape apparatus 18 already installed therein, thereby reducing on site installation, as automatic escape apparatus 18 can be installed by any one who can install a normal door in reinforced doorway 16. Second, door 14 is securely fitted into reinforced doorway 16 via at least two hinges 20 at the side of door 14. Therefore, door 14 acts as a central anchoring point for installing automatic escape apparatus 18 therein. Nevertheless, door 14 operates like a conventional secure door and is able to swing horizontally. Third, automatic escape apparatus 18 which is installed in door 14, is quickly available for use at a plurality of openings or windows 22, by passing a cord 44 of automatic escape apparatus 18 to any one of openings or windows 22. Automatic escape apparatus 18 is configured so that automatic escape apparatus 18 is long enough to reach all openings or windows 22. Moreover, escape apparatus 18 is very reliable as it is easily released from door 14 and escape apparatus 18 allows for quick escape from a building, as will be described below with respect to FIG. 4. Fourth, automatic escape apparatus 18 is concealed by door 14 when automatic escape apparatus 18 is not in use. Fifth, automatic escape apparatus 18 is stored within door 14, thereby automatic escape apparatus 18 does not take away from usable space within a building. It should also be noted that door 14 has the same depth as a standard secure door, the depth being approximately 4 cm or more.

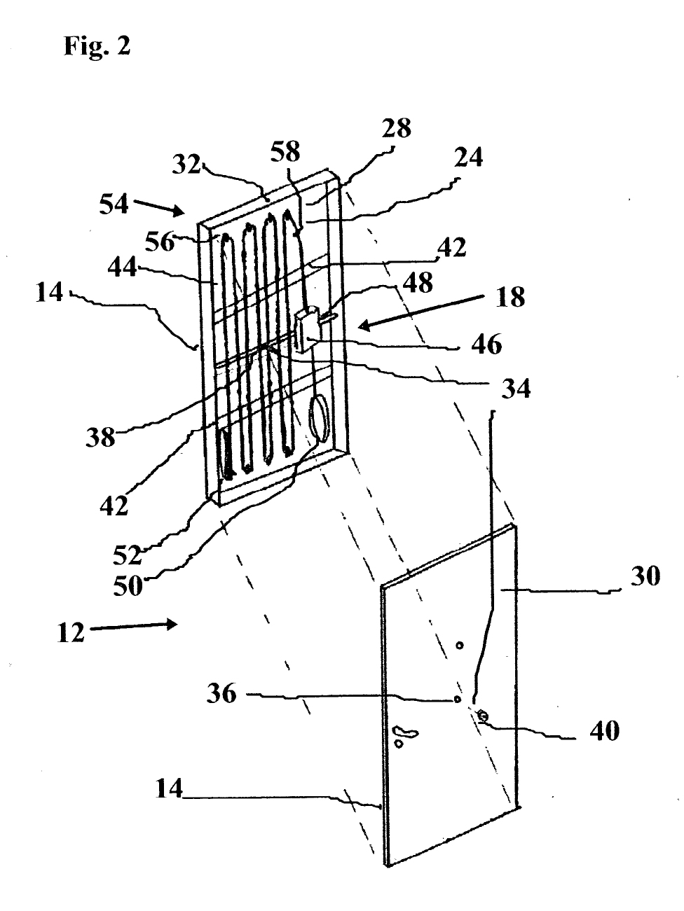

Reference is now made to FIG. 2, which is an exploded schematic orthogonal view of emergency escape system 12. Emergency escape system 12 includes automatic escape apparatus 18 and door 14, which is hollow. Door 14 has an internal volume 24. Automatic escape apparatus 18 is wholly storable within internal volume 24. Therefore, automatic escape apparatus 18 is concealed within door 14. Door 14 has a major panel 28 and a major panel 30 and a plurality of side panels 32. Major panel 28 and major panel 30 are typically formed from metal sheet. Side panels 32 are mechanically connected to the edges of major panel 28 such that side panels 32 are substantially perpendicular to major panel 28. Side panels 32 are typically welded to major panel 28. Alternatively, side panels 32 and major panel 28 are formed as a unitary member. Major panel 28 and major panel 30 are substantially planar. It should be noted that major panel 28 and major panel 30 have been described as substantially planar in that a majority of major panel 28 and a majority of major panel 30 are planar. Major panel 28 and major panel 30 are substantially parallel when door 14 is assembled. Major panel 30 or at least part of major panel 30 is configured to be removable from a remainder of door 14 in order to allow access to automatic escape apparatus 18. Door 14 includes a securing arrangement 34, which is configured to allow removal of major panel 30, or at least part of major panel 30 from the remainder of door 14 with a simple and fast action. Securing arrangement 34 is typically includes a bolt 38 and a securing member 40. One end of bolt 38 is welded to the interior of door 14 so that the direction of elongation of bolt 38 is perpendicular to major panel 28. Major panel 30 is secured to the remainder of door 14 by passing the other non-welded end of bolt 38 through a hole 36 in door 14 and then fastening securing member 40 on bolt 38. Therefore, major panel 30 is released from the remainder of door 14 removing securing member 40 from bolt 38. It will be apparent to those skilled in the art that securing arrangement 34 can be constructed in various forms. By way of example, securing arrangement 34 can be implemented as a lever operated mechanism whereby turning a lever releases major panel 30 from the remainder of door 14. Door 14 is typically reinforced by a plurality of reinforcing bars 42. Reinforcing bars 42 are typically formed from steel. Reinforcing bars 42 are mechanically connected, typically by welding or bolting, to major panel 28 and side panels 32. It will be apparent to those skilled in the art that door 14 can be constructed in various ways to provide a hollow door with an internal volume for storing automatic escape apparatus 18 therein. Automatic escape apparatus 18 includes cord 44, a release mechanism 46 and two harnesses 50, 52. The diameter of cord 44 is typically within the range of 8 mm to 12 mm. Cord 44 is typically formed from a woven cable which includes metal strands. Cord 44 is generally inflammable. Release mechanism 46 is configured to provide a controlled lowering of a person who is being lowered on cord 44. The rate of lowering by release mechanism 46 is typically in the range of 1 meter per second and 5 meters per second. The optimal rate of lowering by release mechanism 46 is typically in the range of 2 meters per second to 2.5 meters per second. The rate of lowering does not depend upon the weight of the person being lowered by release mechanism 46. Release mechanism includes a friction device (not shown) which includes a plurality of disks (not shown) and a lever system (not shown). The disks are held in position relative to each other by the lever system. Cord 44 is wound around the outside edges of the disks. The friction device maintains a constant preset rate of lowering of a person who is being lowered on cord 44, by the lever system adjusting the distance between the disks and thereby tightening or loosening the length of cord 44 which is between the disks. The tightening of cord 44 which is between the disks is increased when the weight acting upon cord 44 is increased, and vice-versa. Release mechanism 46 is automatically reversible. In other words, release mechanism 46 is configured to automatically control the rate of lowering in whichever direction cord 44 is pulled. Release mechanism 46 is typically cylindrically shaped with a diameter of 20 cm and a depth which is small enough to allow release mechanism 46 to fit within internal volume 24 of door 14. It will be apparent to those skilled in the art how to construct release mechanism 46. Release mechanism 46 is typically bolted or welded to a metal bar 48 which is secured in door 14. The ends of bar 48 are typically welded to side panels 32. Cord 44 is fed through release mechanism 46. Harness 50 is connected to one end of cord 44 and harness 52 is connected to the other end of cord 44. Emergency escape system 12 includes a storage arrangement 54 which is configured to store cord 44 within internal volume 24 of door 14. Storage arrangement 54 is configured to store cord 44 compactly when not in use. In accordance with a most preferred embodiment of the present invention, cord 44 is arranged in a single layer 58 against major panel 28 of door 14 by running cord 44 up and down major panel 28. Cord 44 is then mechanically connected to major panel 28 by one or more holders 56 which are applied at points where cord 44 is bent at the top and bottom of single layer 58. It should be noted that holders 56 may or may not be mechanically connected to cord 44. In other words, holders 56 can be configured to form a loop which is connected to major panel 28 in which cord 44 is held. Holders 56 are sufficiently strong that cord 44 is maintained connected to major panel 28 of door 14 when cord 44 is not in use, however, when cord 44 is needed, cord 44 is easily released from major panel 28 of door 14. Holders 56 are typically formed from soft plastic, rubber or silicon or any elastic plastic material. It should be noted that if necessary, for example when emergency escape system 12 is used in a very large and/or high building, cord 44 is arranged in multiple layers to accommodate a longer cord inside door 14. It will be apparent to those skilled in the art that door 14 can be configured to store various types of escape apparatus that are known in the art, for example, door 14 can be configured to store abseiling equipment or a rope ladder.

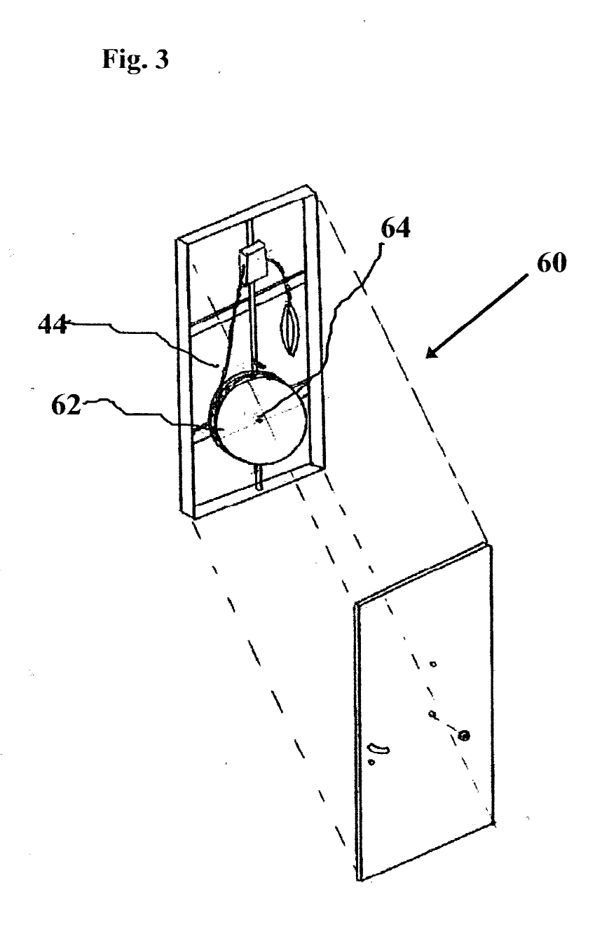

Reference is now made to FIG. 3, which is an exploded schematic orthogonal view of an emergency escape system 60 that is constructed and operable in accordance with an alternate embodiment of the invention. Emergency escape system 60 is the same as emergency escape system 12, except that the storage arrangement of emergency escape system includes a spool 62 instead of holders 56. Cord 44 is wound on spool 62 when not in use. Spool 62 has an axis of rotation 64. Spool 62 is typically connected to bar 48 by welding so that spool 62 can rotate about axis of rotation 64.

Reference is now made to FIG. 4, which is a schematic view of an evacuation of a building 70 using emergency escape system 12. The following description describes how three people escape from building 70 using emergency escape system 12. A first person to escape, a person 66 wears harness 50. Any slack in cord 44 between person 66 and release mechanism 46 is removed by pulling on the side of the cord having harness 52. Person 66 then exits from a window 68 of building 70 at a position 72. Person 66 is lowered in harness 50 by release mechanism 46 slowly releasing cord 44. Person 66 is lowered in a controlled manner, via a position 76 to the ground at a position 78. A second person (not shown) to escape from building 70, wears harness 52 and evacuates from building 70 in the same way as person 66. When this second person who is wearing harness 52 is lowered from building 70, harness 50 moves towards release mechanism 46. Therefore, a third person (not shown) to escape from building 70 wears harness 50 and evacuates from building 70 in the same way as the previous two people. Therefore, emergency escape system 12 is configured for a substantially continuous multiple use during a single evacuation.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. An emergency escape system comprising:
(a) an escape apparatus; and
(b) a hollow door, said door having an internal volume, wherein:
(i) a majority of said escape apparatus is storable within said internal volume; and
(ii) a part of said door is removable in order to access said escape apparatus.

2. The system of claim 1, wherein said escape apparatus is configured to be wholly storable within said internal volume.

3. The system of claim 1, wherein said escape apparatus is concealed within said door.

4. The system of claim 1, wherein said door has a first major panel and a second major panel, said first panel and said second panel being substantially planar.

5. The system of claim 4, wherein said first panel and said second panel are substantially parallel.

6. The system of claim 1, wherein said door has a first major panel and a second major panel, said first major panel being configured to be removable from a remainder of said door in order to allow access to said escape apparatus.

7. The system of claim 1, wherein said door is configured for fitting in a building using at least one hinge such that, when fitted in said building, said door is able to swing horizontally.

8. The system of claim 1, wherein said door includes a securing arrangement which is configured to allow removal of said part from a remainder of said door.

9. The system of claim 1, wherein said door is reinforced.

10. The system of claim 1, wherein said escape apparatus includes a cord.

11. The system of claim 10, wherein said escape apparatus includes a storage arrangement configured to store said cord within said door.

12. The system of clam 11, wherein said storage arrangement includes a spool.

13. The system of claim 11, wherein said storage arrangement includes at least one holder configured to connect said cord to said door, said at least one holder being sufficiently strong that said cord is maintained connected to said door when said cord is not in use and when said cord is needed, said cord is easily released from said door.

14. The system of claim 10, wherein said cord is inflammable.

15. The system of claim 10, wherein said escape apparatus includes a release mechanism which is configured to provide a controlled lowering of a person being lowered on said cord.

16. The system of claim 10, wherein said escape apparatus includes at least one harness, said harness being configured for connection to said cord.

17. The system of claim 1, wherein said escape apparatus is configured for a substantially continuous multiple use during a single evacuation.
